(19) United States
(12) Patent Application Publication
(10) Pub. No.: US 2025/0284168 A1
(43) Pub. Date: Sep. 11, 2025

(54) SYSTEM AND METHODS TO EXPLOIT PHOTOSWITCHABLE OPTOELECTRONIC PROPERTIES OF 2D HYBRID STRUCTURES

(71) Applicants: Purdue Research Foundation, West Lafayette, IN (US); University of St. Thomas, St. Paul, MN (US)

(72) Inventors: Jong Hyun Choi, West Lafayette, IN (US); Jaehoon Ji, Princeton, NJ (US); Sewon Park, West Lafayette, IN (US); Jeong Ho You, St. Paul, MN (US)

(73) Assignees: Purdue Research Foundation, West Lafayette, IN (US); University of St. Thomas, St. Paul, MN (US)

(21) Appl. No.: 19/072,726

(22) Filed: Mar. 6, 2025

Related U.S. Application Data
(60) Provisional application No. 63/562,867, filed on Mar. 8, 2024.

(51) Int. Cl. G02F 1/157; G02F 1/01

(52) U.S. Cl. CPC G02F 1/157; G02F 1/0126; G02F 2202/14

(57) ABSTRACT

A DEVICE includes a substrate, an atomic monolayer of a transition metal dichalcogenide (TMD) material formed on the substrate, and a layer of photochromic diarylethene (DAE) disposed on the TMD material, wherein the photochromic DAE layer has a thickness of between about 1 nm to 10 nm, and wherein applying energy via a pump source causes the DEVICE to luminesce at a steady state level of intensity.

### CROSS-REFERENCE TO RELATED APPLICATIONS

The present non-provisional patent application is related to and claims the priority benefit of U.S. Provisional Patent Application Ser. 63/562,867, filed Mar. 8, 2024, the contents of which are hereby incorporated by reference in its entirety into the present disclosure.

### STATEMENT REGARDING GOVERNMENT FUNDING

This invention was made with government support under 2151887 ECCS awarded by the National Science Foundation. The government has certain rights in the invention.

### TECHNICAL FIELD

The present disclosure generally relates to photoswitchable optoelectronics and in particular to photoswitchable optoelectronics with 2-dimensional hybrid structures.

### BACKGROUND

This section introduces aspects that may help facilitate a better understanding of the disclosure. Accordingly, these statements are to be read in this light and are not to be understood as admissions about what is or is not prior art.

2D transition metal dichalcogenides (TMDs) have gained significant attention in recent years due to their remarkable physical properties, making them attractive for nanoelectronics. Recent advances in 2D TMDs have revealed their versatility, characterized by van der Waals interactions, high mobility and layer-number-dependent indirect-direct bandgap transitions. These unique attributes can lead to valley polarization and strong interlayer photoluminescence (PL) emissions via excitonic recombination. There have been various studies to control these factors and modulate charge transport in TMDs, including gate-induced electric doping, polarization switching, and spin-valley tuning. However, these conventional approaches present challenges and complexities in manufacturing and characterization processes. In the case of gate-induced control, for example, it is necessary to construct a back-gate field-effect transistor (FET) to regulate carriers, which, in turn, requires low contact resistance and high-quality contact. For polarization switching and spin-valley tuning, high magnetic fields are needed.

MoS₂ is a notable member of the 2D TMD family. It is considered as a promising candidate for nanoelectronics and optoelectronics due to its intriguing properties arising from its unique layered lattice structure. Its versatile characteristics include thickness-dependent direct-indirect bandgap transitions, high carrier mobility, and strong absorption, along with n-type semiconductive behaviors. These properties have been exploited to demonstrate high-performance devices including photodetectors, logic circuits, sensors, and field effect transistors (FETs). Efforts to fully explore the potential of MoS₂ include understanding how charge transport can be modulated at its heterointerfaces. The typical fabrication approach includes preparing vertical heterostructures by stacking various thin 2D layers held together to form heterojunctions such as p-n, n-p-n, or p-n-p junctions. These methods involve laborious and complex procedures, often resulting in low efficiency and risk of contamination. For example, dry transfer methods utilize an elastomeric stamp that involves a manual process requiring extremely high accuracy. Additionally, wet transfer of large-area 2D materials grown by chemical vapor deposition (CVD) methods may involve contamination and oxidation from etchants or cleaning processes, leading to degradation in material quality.

The integration of TMDs with organic molecular systems to form 2D hybrid heterostructures has emerged as an effective method for studying charge transport mechanisms in TMDs. The use of organic layers offers multiple benefits, including simplicity, non-destructive doping, defect passivation, adaptability, and environmental sensitivity.

However, a robust hybrid structure that can be used in photoswitchable devices remains elusive. What is needed is a device that can be optically or electrically manipulated in order to provide effective opto-switching capabilities.

Therefore, there is an unmet need for a novel structure, devices and a system made of said devices, and a method of making the structure that can be used in photoswitchable devices which can provide a robust opto-switching capabilities.

### SUMMARY

A DEVICE is disclosed. The DEVICE includes a substrate, an atomic monolayer of a transition metal dichalcogenide (TMD) material formed on the substrate, and a layer of photochromic diarylethene (DAE) disposed on the TMD material. The photochromic DAE layer has a thickness of between about 1 nm to 10 nm. Applying energy via a pump source causes the DEVICE to luminesce at a steady state level of intensity.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1a is a schematic of a purely optical device according to one embodiment of the present disclosure.

FIG. 1b is a conceptual graph of luminescence intensity vs. wavelength for the device of FIG. 1a.

FIG. 2a is a similar device as in FIG. 1a, schematically shown but with two terminals called out as drain and source, thus providing an optoelectrical device.

FIG. 2b is a conceptual I_{DS} vs. V_{DS} curve wherein the modulation light is changed between UV and visible light indicating a discernable change in the IV characteristics which can be gauged by a supporting circuit using, e.g., operational amplifiers and comparators to discern between the two switchable states.

FIG. 3 is a schematic of a three-terminal device (e.g., a drain-source-gate device).

FIG. 4 is a conceptual graph of I_{DS} vs. V_{GS}, where again a discernable change in the IV characteristics can be seen depending on the switching of the modulation light, e.g., from UV to visible light, which can be used by an external circuit to discern the optical switching.

FIG. 5a is a chemical representation of the isomerization scheme for the photochromic diarylethene (DAE) derivative used in the present disclosure in both open and closed isomer states.

FIG. 5b shows alignment of the valence band maximum (VBM) and conduction band minimum (CBM) of monolayer MoSe₂ against the highest occupied molecular orbital (HOMO) and lowest unoccupied molecular orbital (LUMO energy levels of open- (visible light modulation light) and closed-form (ultraviolet (UV) modulation light) isomers of DAE.

FIG. 5c provides graphs of absorbance vs. wavelength in nm for DAE molecules in a chloroform solution (˜0.02 mg/mL) exposed to varying doses of UV modulation light irradiation.

FIG. 5d provides graphs of absorbance vs. wavelength in nm for samples subjected to 2 minutes of UV irradiation followed by visible (Visible light) modulation light irradiation.

FIG. 6a is an energy diagram for density of states (DOS) of closed- and open-forms of DAE, highlighting a shift of the LUMO and HOMO energies through photoisomerization.

FIG. 6b shows how in the hybrid DAE-MoSe₂ monolayer, the LUMO level of the closed isomer becomes lower than the MoSe₂ CBM, while it is higher with the open-form.

FIG. 6c is an energy diagram which provides DOS from density functional theory (DFT) calculations for the 1 L, 2 L, and 3 L MoS₂-closed DAE hybrids.

FIG. 6d is an energy diagram which provides DOS from density functional theory (DFT) calculations for the 1 L, 2 L, and 3 L MoS₂-open DAE hybrids.

FIG. 6e and FIG. 6f are (FIG. 6e) atomic force microscopy (AFM) images of 2 L MoS₂ flake and 2 L MoS₂-DAE hybrid, with the corresponding height differences depicted in FIG. 6f, which are graphs of height in nm vs position in μm, the thickness of the 2 L MoS₂ flake is ˜1.60 nm, while the DAE measures ˜2.11 nm, of 3 L MoS₂ flake, and 3 L MoS2-DAE hybrid, with the corresponding height differences.

FIG. 7a is a bright-field image of mechanically exfoliated pristine MoSe₂ on a SiO₂/Si substrate.

FIG. 7b and FIG. 7c are AFM images of (FIG. 7b) MoSe₂/DAE and (FIG. 7c) MoSe₂ corresponding to the monolayer flake shown in (FIG. 7a).

FIG. 7d are graphs of height in nm vs. position in μm which presents the height information derived from the AFM images, revealing the thickness of monolayer MoSe₂ of about 0.8 nm and the DAE layer of about 2 nm.

FIG. 7e provides graphs of photoluminescence (PL) intensity vs. input energy in eV providing PL spectra of MoSe₂/DAE (in linear scale) measured under a confocal Raman microscope with a 785-nm diode laser excitation.

FIG. 7f is a graph of normalized PL intensity vs. photo-irradiation which shows remarkable stability of MoSe₂/DAE photoswitching capabilities with a steady quenching ratio, ranging between 70% to 85%.

FIG. 7g, FIG. 7h, and FIG. 7i, are graphs of PL intensity vs. wavelength providing PL intensity of 1 L, 2 L, and 3 L MoS₂-DAE samples measured under alternating UV-visible irradiation.

FIG. 7j and FIG. 7k, are AFM image of MoS₂ flakes featuring 1 L (FIG. 7j), 2 L, and 3 L (together FIG. 7k), with the boundaries highlighted by dotted lines.

FIG. 8a is a schematic of a Conductive-AFM setup where a TMD flake is exfoliated onto an ITO substrate and then coated with the DAE layer while applying a DC bias voltage of ±2 V and limiting the current to ±12 nA to protect the samples and the tip from localized charges.

FIG. 8b provides graphs of current in nA (see I_{DS} with reference to FIG. 2a and FIG. 2b) vs. DC bias voltage (see V_{DS} with reference to FIG. 2a and FIG. 2b).

FIG. 8c, FIG. 8d, and FIG. 8e are results of conductive-AFM measurements on photoswitched hybrid samples under UV and visible irradiation resulting in (FIG. 8c) 1 L MoS₂-DAE, (FIG. 8d) 2 L MoS₂-DAE, and (FIG. 8e) 3 L MoS₂-DAE.

FIG. 9a, FIG. 9b, and FIG. 9c are optical microscope images of MoSe₂ exfoliated on an ITO glass substrate and measured surface potential of MoSe₂/DAE (FIG. 9a) prior to any exposure following an exposure to (FIG. 9b) visible and (FIG. 9c) UV light.

FIG. 9d, FIG. 9e, and FIG. 9f are energy diagram of MoSe₂ in three different states: (FIG. 9d) before, (FIG. 9e) partially, and (FIG. 9f) after reaching equilibrium at the hybrid interface.

FIG. 10 is an energy band diagram, which illustrates the fundamental mechanisms involved in MoS₂-DAE hybrids based on DFT calculations.

FIG. 11 is a chemical representation of a synthesis process according to the present disclosure.

FIG. 12 is a chemical representation which shows the process of synthesis of DAE (2-(3,5-bis(trifluoromethyl)phenyl)-4-bromo-5-methylthiophene).

FIG. 13 is a chemical representation of the desired DAE (4,4′-(perfluorocyclopent-1-ene-1,2-diyl)bis(2-(3,5-bis(trifluoromethyl)phenyl)-5-methylthiazole).

FIG. 14 provides NMR results for ¹H-NMR (600 MHz, CDCl₃): δ (ppm)=8.22 (s, 2H, CHar), 7.82 (s, 1H, CHar), 2.41 (s, 3H, CH3).

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel structure, devices and a system made of said devices and a method of making the structure are disclosed herein that can be used in photoswitchable devices which can provide a robust opto-switching capabilities. Towards this end a structure is disclosed which includes a monolayer (i.e., a 2-dimensional (2D)) of transition metal dichalcogenides (TMDs) disposed on a substrate along with a thin film of photochromic diarylethene (DAE) disposed on the TMD monolayer is disclosed which when pumped with an energy source luminesces in the form of an optical emission. The novel structure when subjected to a modulating light, modulates the optical emission.

In the present disclosure Photoswitchable organic molecules such as photochromic DAEs are used as leading candidates for light-controlled charge transport at the interface between these molecules and TMDs. When exposed to light, photochromic molecules undergo isomerization to another structural form. In case of DAE, isomerization modulates between an open isomeric state and a closed isomeric state which causes shifts in their highest occupied molecular orbital (HOMO) and lowest unoccupied molecular orbital (LUMO) energy levels. Such photo-induced shifting has been exploited in the present disclosure for the modulation of TMDs. Specifically, this switching between states can be used to make a purely optical or an optoelectrical device that is photoswitchable when exposed to various modulation lights. For example, in the case of a purely optical device, the device's luminescence intensity decreases when subjected to an ultraviolet (UV) light as more of the DAE molecules transition to a closed isometric state, thus causing a drop in intensity of the luminescence. The higher intensity of the UV light, the more molecules make said transition. Thus, the luminescence intensity decreases in presence of increasing UV intensity, until the luminescence completely stops. Conversely, the device's luminescence intensity increases when subjected to a visible light as more of the DAE molecules transition to an open isometric state, thus causing an increase in intensity of the luminescence. The luminescence intensity increases in presence of increasing visible light intensity, until the luminescence reaches a maximum. It should be appreciated that the luminescence occurs only when the device is subjected to a pump energy such as a photonic energy (e.g., a laser) or electrical energy, or heat. Alternatively, in an optoelectrical device, e.g., a device with two or three terminals (e.g., a drain-source device for a two terminal device, or a drain-source-gate device for a three terminal device), current-voltage (IV) curves across the drain-source terminals exhibit a discernable switch between application of UV vs. visible light, thus allowing the device to be viewed as a photoswitchable optoelectrical device.

The charge transfer interaction at the hybrid heterointerfaces depends on TMD layer numbers as well as photochromic materials. The present disclosure provides evidence that in presence of more than one layer of TMD, the desired photoswitching fails, thus making it clear that a monolayer of TMD is needed. The TMD material is selected from the group consisting of molybdenum disulfide (MoS₂), molybdenum diselenide (MoSe₂), and combinations thereof.

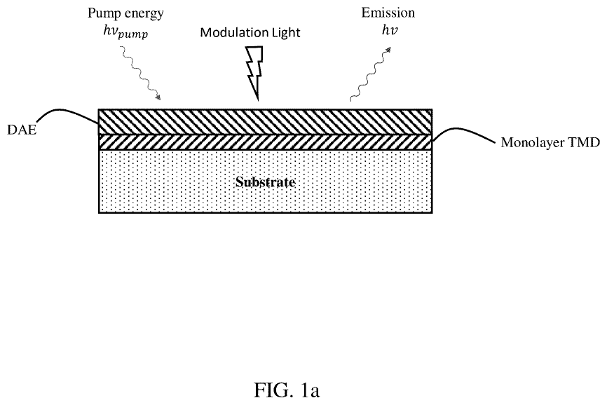

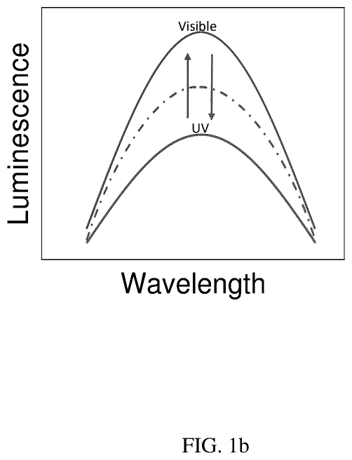

Referring to FIG. 1a, a schematic of a purely optical device according to one embodiment of the present disclosure is provided. The device shown in FIG. 1a includes a substrate (which can be any suitable substrate selected from the group consisting of glass, Si, SiO₂, doped Si, SiC, Germanium, boron nitride, carbon, crystals, gallium arsenide, and combinations thereof), a monolayer of the TMD material disposed on the substrate, and layer of the DAE material disposed on the TMD monolayer. As discussed above, when a pump energy is input into the device shown as pump energy, e.g., photon energy hvₚᵤₘₚ, the device (specifically, the TMD) begins to luminesce, shown as emission hv. Without application of a modulation light, the luminescence emission is considered steady state. If the pump energy is removed, the device ceases to luminesce. However, when a modulation light is applied, the luminescence intensity switches from one state to another as the DAE molecules transitioned from one state to another. In particular, if the modulation light is, e.g., a UV light, more of the DAE molecules transition to a closed state, thus causing the intensity of the luminescence emission to decrease. There is a sliding scale between intensity of the applied UV light and the decrease in the intensity of the luminescence emission until the device seizes to luminesce altogether. Alternatively, if the modulation light is a visible light, more of the DAE molecules transition to an open state, thus causing the intensity of the luminescence emission to increase. Similarly, there is a sliding scale between intensity of the applied visible light and the increase in the intensity of the luminescence emission until the device reaches a maximum luminescence. This effect is schematically shown in FIG. 1b which is a graph of luminescence intensity vs. wavelength. The graph shows that at some wavelength the luminescence is a maximum, with or without application of modulation light. In case there is no modulation light, the resulting luminescence is shown as a dashed line, referred to herein as the steady state. Application of UV light, causes the luminescence to decrease from this steady state to a lower intensity. Conversely, applying a visible light, causes the luminescence to increase from this steady state to a higher intensity. Application of the modulation light actively causes the luminescence intensity to decrease or increase. However, removing the modulation light after applying the modulation light thus causing a change in the intensity in luminescence emission, results in the device having a half-life (i.e., a long period of time, e.g., half day or longer, to return to the steady state).

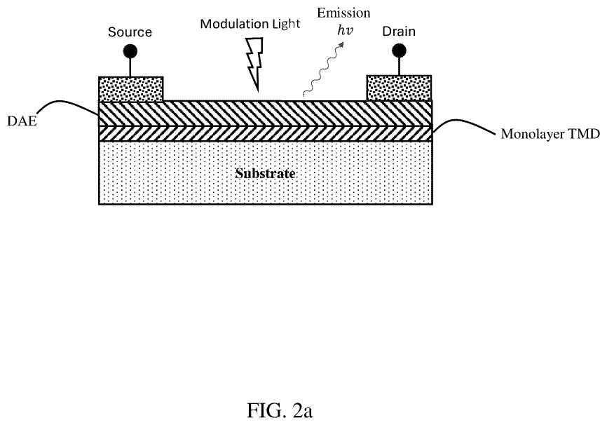

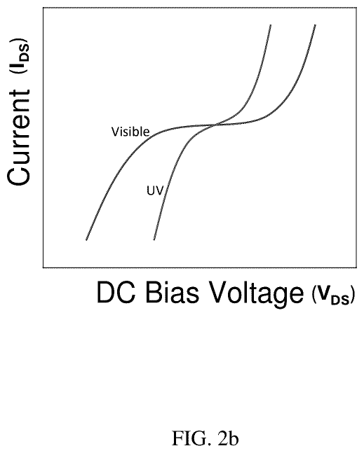

Referring to FIG. 2a, a similar device as in FIG. 1a is schematically shown, but with two terminals called out as drain and source, thus providing an optoelectrical device. The two terminals allow application of electrical energy as a replacement for optical pump energy. That is, once a voltage is applied to the drain-source terminals, the device begins to luminesce as called out by emission hv. Without application of the modulation light, the luminescence is at a peak at a particular wavelength as shown in FIG. 1b. However, by applying the modulation light, the luminescence intensity decreases (e.g., in case of a UV light) or increases (e.g., in case of a visible light). The above-description of the luminescence intensity change with respect to FIG. 1b applies to the device shown in FIG. 2a. This device can be used purely as an optical switching device (i.e., by gauging intensity variation, depending on the modulation light), or as an optoelectrical switching device. That is, instead of gauging the change in luminescence intensity, a change in the IV curve can be used to establish switching. Referring to FIG. 2b, a generic I_{DS} vs. V_{DS} curve is shown wherein the modulation light is changed between UV and visible light indicating a discernable change in the IV characteristics which can be gauged by a supporting circuit using, e.g., operational amplifiers and comparators to discern between the two switchable states.

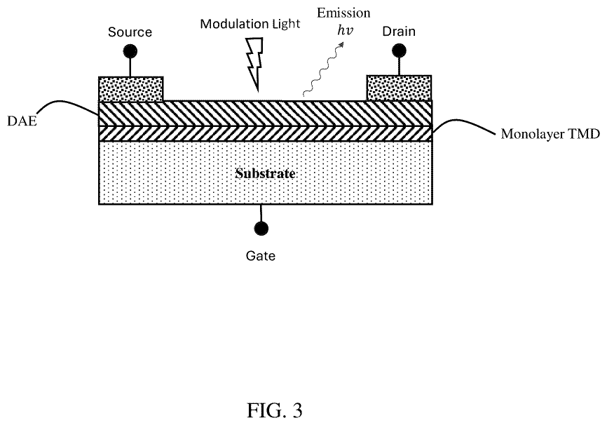

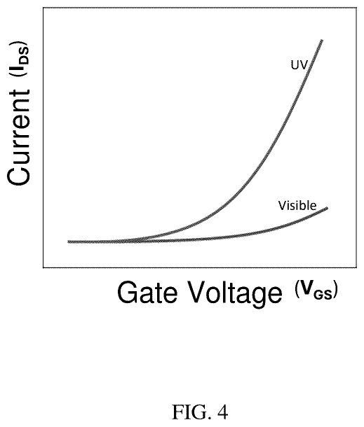

Referring to FIG. 3, a three-terminal device (e.g., a drain-source-gate device) is schematically shown. As in the two terminal device shown in FIG. 2a, the three-terminal device includes an additional terminal (a gate) that is coupled to the substrate. In the three-terminal device shown in FIG. 3, the gate regulates charge carrier concentration. Adjusting the substrate voltage influences key factors such as threshold voltage, charge mobility, and injection efficiency. When combined with light-responsive molecules such as DAE, charge transfer interactions at the interface can be further modified based on the substrate potential. These voltage changes shift the band alignment, impacting optoelectronic behaviors such as charge transport and luminescence. The resulting effect is shown in FIG. 4 which is a graph of I_{DS} vs. V_{GS}, again a discernable change in the IV characteristics can be seen depending on the switching of the modulation light, e.g., from UV to visible light, which can be used by an external circuit to discern the optical switching.

The structure and device of the present disclosure elucidates dynamic and reversible photo-modulations of monolayer TMD/DAE hybrid structures both experimentally and theoretically. Density functional theory (DFT) calculations are used to design and understand the interfaces and photo-processes. DAE undergoes unique transformations when exposed to UV or visible light, switching between two isomers, closed and open forms. We demonstrate that its highest occupied molecular orbital (HOMO) and lowest unoccupied molecular orbital (LUMO) energy levels shift during the transformation and that the photoswitch can be exploited for modulating optoelectronic properties of monolayer MoSe₂. We also show that photoluminescence (PL) intensities are modulated drastically by alternating UV and Vis light irradiation, which may be cycled repeatedly. Conductive atomic force microscopy (C-AFM) and Kelvin probe force microscopy (KPFM) confirm the light-controlled charge transfer at the hybrid interface. Our findings will provide critical insights into fundamental properties in 2D semiconductors and offer new opportunities for photoswitchable hybrid devices.

According to the present disclosure, we utilized DAE molecules to investigate photoswitchable charge transfer behaviors for various TMD (e.g., MoS₂) layer numbers from monolayer (1 L) to trilayer (3 L). The different layer number of MoS₂ flakes leads to distinct conduction band minimum (CBM) and valence band maximum (VBM) energies. We measured the PL emissions of MoS₂ after DAE isomerization using UV and visible light irradiation and observed distinct behaviors from the 1 L, 2 L, and 3 L MoS₂-DAE. Conductive atomic force microscopy (C-AFM) was also performed to evaluate light-induced changes in current in the 1 L, 2 L, and 3 L hybrid systems. Our observation indicates monolayer MoS₂ interacts with DAE differently than bilayer or trilayer. To elucidate underlying mechanisms, we carried out DFT calculations to investigate the layer-number-dependent CBM and VBM energies of MoS₂ against the LUMO and HOMO levels of the open and the closed DAE isomers. We identified a hole transfer mechanism that modulated the properties of 1 L MoS₂, but not 2 L or 3 L, due to the energy level alignment. This work provides critical insights on the thickness-dependent characteristics of MoS₂-organic heterojunctions, laying the groundwork for advanced photoswitchable hybrid devices.

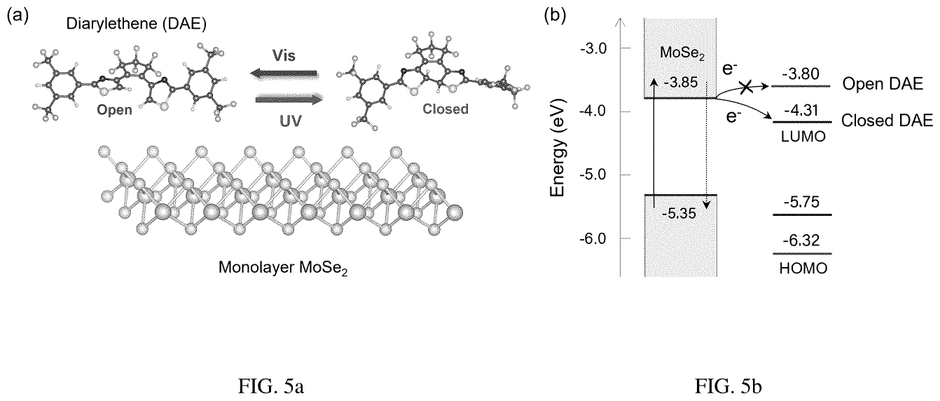

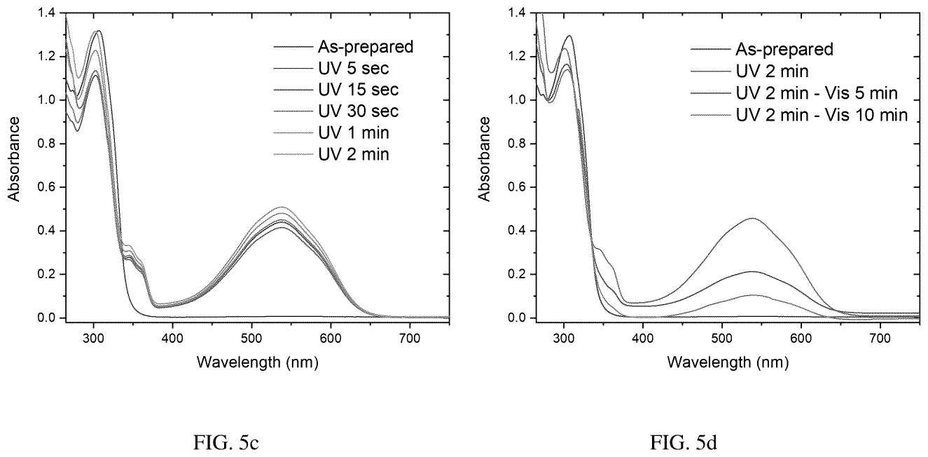

Referring to FIG. 5a, a chemical representation of the isomerization scheme for the DAE derivative used in the present disclosure is provided in both open and closed isomer states. As discussed above, irradiation of UV and visible (Vis) light herein referred to as modulation light switches the molecular structure of DAE, transitioning between π-conjugated closed and cross-conjugated open forms according to the present disclosure, the photoswitchability of DAE molecules is designed to engineer charge transfer mechanisms in MoSe₂/DAE and thereby modulate the optoelectronic properties of the TMD monolayers. UV and visible irradiation will thus control the exciton formation and behavior. Our scheme is illustrated in FIG. 5b, where the valence band maximum (VBM) and conduction band minimum (CBM) of monolayer MoSe₂ are plotted against the two sets of HOMO and LUMO energy levels corresponding to the open and the closed DAE photoisomers. Both MoSe₂ and DAE energies were obtained from DFT calculations (vide infra) which are in excellent agreement with previous report. The CBM and VBM energies against the vacuum level are approximately −3.85 eV and −5.35 eV, respectively. The energy levels are consistent with previously reported data. The LUMO and HOMO levels of open-form DAE are approximately −3.80 eV and −6.32 eV, while −4.31 eV and −5.75 eV for closed-form isomers. In particular, FIG. 5b shows alignment of the VBM and CBM of monolayer MoSe₂ against the HOMO and LUMO energy levels of open- (Vis) and closed-form (UV) isomers of DAE. The HOMO and LUMO levels of open-form DAE are lower and higher than the VBM and CBM of MoSe₂, respectively. In contrast, the closed-form has its LUMO level lower than the CBM, while its HOMO level remains lower than the VBM. As a result, photoexcited electron transfer may be energetically favored from MoSe₂ to closed-form DAE, whereas it will be forbidden between MoSe₂ and open-form DAE. Overall, photoswitching can regulate charge transfer between MoSe₂ and DAE.

The open isomer absorbs exclusively in the UV region, whereas the closed isomer displays absorption also in the visible spectrum as shown in FIGS. 5c and 5d. Specifically, FIG. 5c provides graphs of absorbance vs. wavelength in nm for DAE molecules in a chloroform solution (˜0.02 mg/mL) exposed to varying doses of UV irradiation and FIG. 5d provides graphs of absorbance vs. wavelength in nm for samples subjected to 2 minutes of UV irradiation followed by visible (Vis) irradiation. The photoswitching behavior of DAE molecules are retained within deposited layers on top of TMD monolayer.

In reference to FIG. 5b, it should be noted that the LUMO level of closed-form DAE is below the CBM of monolayer MoSe₂, whereas that of the open-form is above the CBM. Both isomers have their HOMO energies below the VBM. Thus, the photoexcitation in the MoSe₂ monolayer will create excitons, excited electrons in the conduction band and holes in the valence band. The electrons may be transferred to the LUMO of the closed-form DAE, but not the open-form. The hole transfer to either form is energetically not favorable. Therefore, it is possible to facilitate the photoexcited electron transfer by irradiating UV (to form closed DAE) or suppress it with visible light (to form open-DAE). As a result, UV irradiation will reduce the radiative recombination of photoexcited electron-hole pairs, resulting in a PL quenching. Visible illumination will isomerize the DAE into the open-form and recover the emission properties. This mechanism is reversible and fast, occurring on the picosecond timescale.

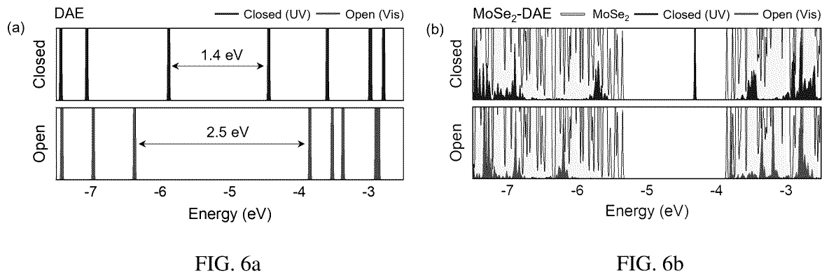

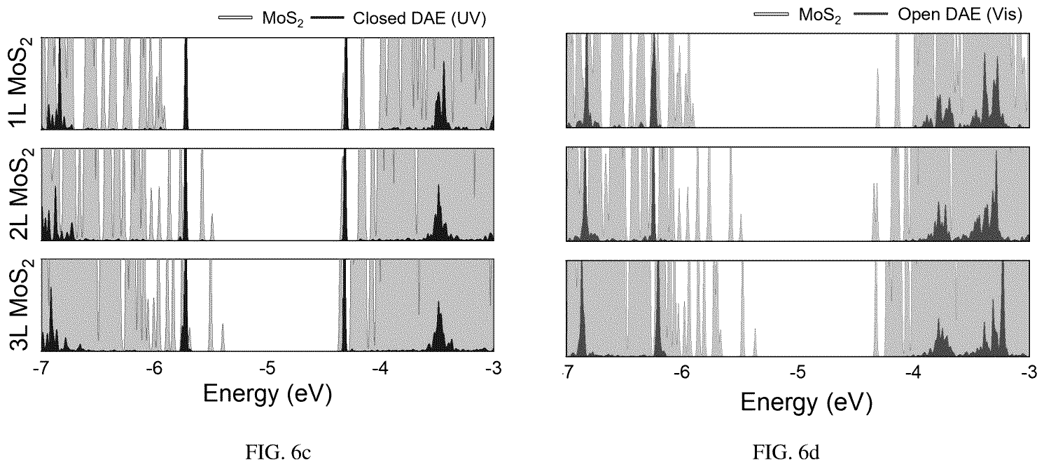

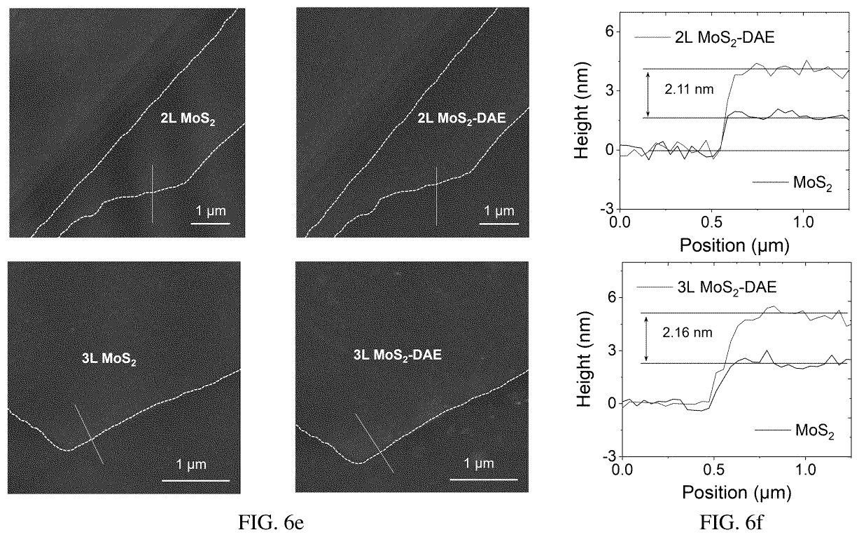

The energies of monolayer MoSe₂, DAE, and hybrid MoSe₂/DAE were obtained from DFT calculations using VASP. Referring to FIG. 6a, the electronic states of DAE isomers with the vacuum level set as zero are presented. Specifically, DOS of closed- and open-forms of DAE, highlighting a shift of the LUMO and HOMO energies through photoisomerization are shown. The vacuum level is set to zero. The HOMO and LUMO levels of the closed-form (under UV irradiation) are approximately −5.75 eV and −4.31 eV, respectively; for the open-form (irradiated by visible light), they are about −6.32 eV and −3.80 eV. The transformation from the closed isomer to the open raises the LUMO energy level and lowers the HOMO, resulting in an increase in the HOMO-LUMO gap by about 1.1 eV. The density of states (DOS) of the DAE/MoSe₂ monolayer slab is shown in FIG. 6b. Specifically, FIG. 6b shows in the hybrid DAE-MoSe₂ monolayer, the LUMO level of the closed isomer becomes lower than the MoSe₂ CBM, while it is higher with the open-form. This photoswitchability of DAE provides available states within the bandgap for photoinduced electron transfer from MoSe₂ to closed-form DAE (but not to open-form) and allows for a photo-modulation of optoelectronic properties of monolayer MoSe₂. The VBM of monolayer MoSe₂ is set as zero for comparison purposes. With the open DAE isomer, both HOMO and LUMO stay outside the bandgap of MoSe₂. When the DAE isomerizes to the closed-form, the LUMO shifts into the bandgap, providing available states for the electrons in MoSe₂ to transfer to. The HOMO remains outside the bandgap. Thus, there would be no hole transfer. The DFT results support our photo-modulation scheme.

Additionally, DOS were obtained from DFT calculations for the 1 L, 2 L, and 3 L MoS₂-DAE hybrids as shown in FIG. 6c (reference is also made to FIG. 6e and FIG. 6f which are (FIG. 6e) AFM images of 2 L MoS₂ flake and 2 L MoS₂-DAE hybrid are shown, with the corresponding height differences depicted in FIG. 6f, which are graphs of height in nm vs position in μm, the thickness of the 2 L MoS₂ flake is ˜1.60 nm, while the DAE measures ˜2.11 nm, of 3 L MoS₂ flake, and 3 L MoS2-DAE hybrid, with the corresponding height differences depicted in FIG. 6f. The thickness of the 3 L MoS₂ flake is ˜2.28 nm, and the DAE measures ˜2.16 nm). The energy states of an isolated DAE photoisomer were calculated, setting the vacuum level to zero. The structural transformation of DAE between its open and closed states leads to considerable shifts in the HOMO and LUMO levels.

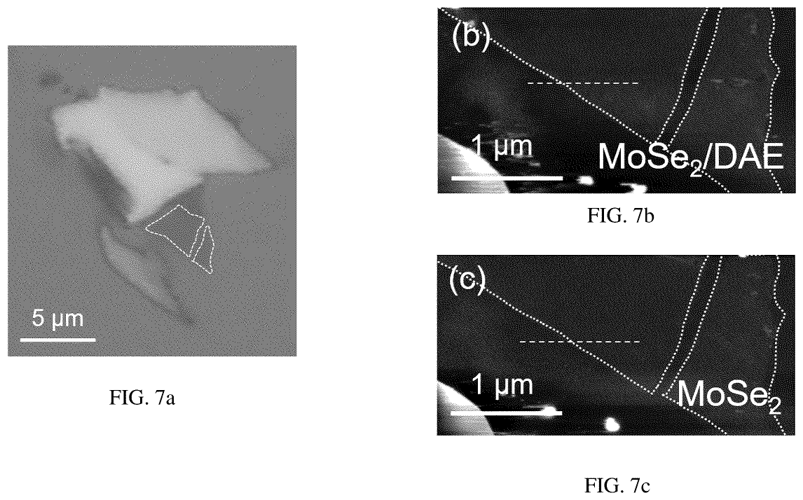

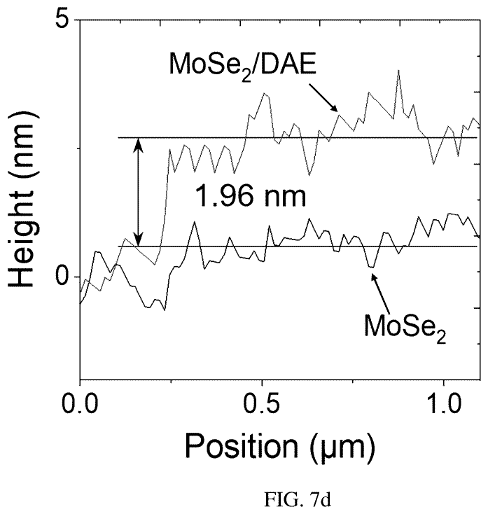

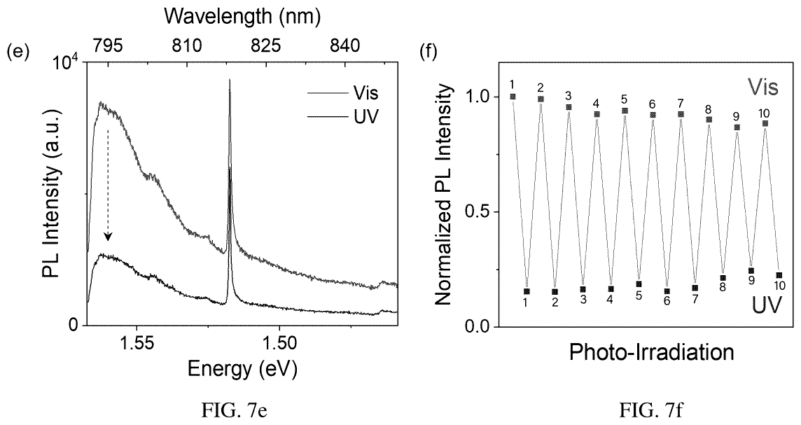

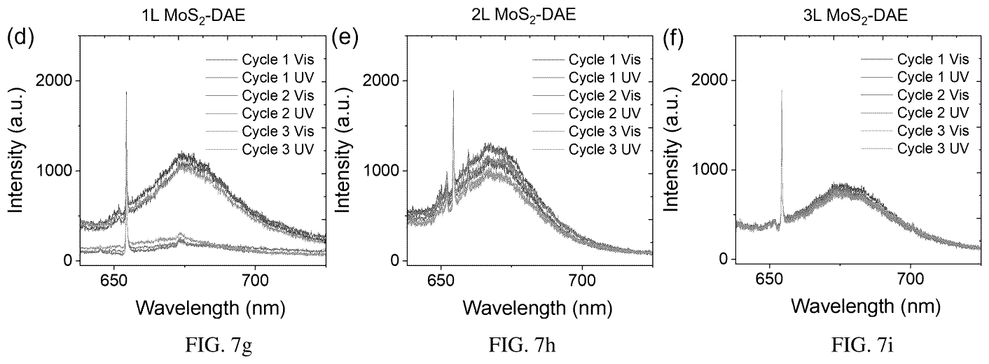

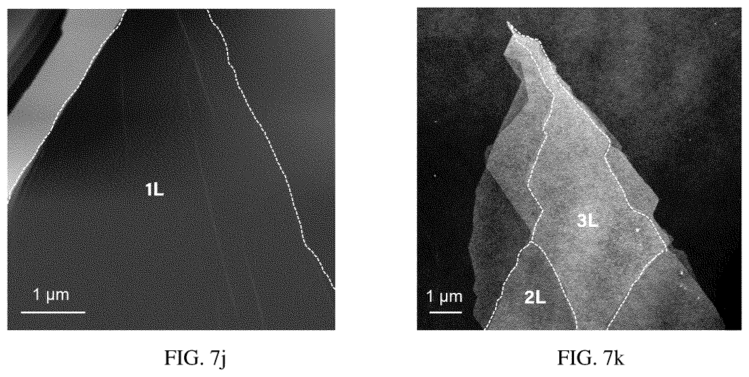

To examine the photoswitching of the structure of the present disclosure, we first investigated the PL quenching effect. MoSe₂ flakes were prepared on a SiO₂/Si substrate via mechanical exfoliation and annealed at 250° C. for an hour. This procedure enhances the PL intensity of the n-type MoSe₂ by depleting excess electrons. The samples were then immersed in a DAE chloroform solution, forming a layer of DAE molecules on MoSe₂. Referring to FIG. 7a an optical image of MoSe₂ is provided with dotted lines marking the monolayer flake's boundary. Specifically, FIG. 7a is a bright-field image of mechanically exfoliated pristine MoSe₂ on a SiO₂/Si substrate. To examine the surface and height of the MoSe₂/DAE hybrid before and after functionalization, we conducted atomic force microscopy (AFM) measurements, as depicted in FIG. 7b and FIG. 7c which are AFM images of (FIG. 7b) MoSe₂/DAE and (FIG. 7c) MoSe₂ corresponding to the monolayer flake shown in (FIG. 7a). Referring to FIG. 7d, graphs of height in nm vs. position in μm are provided which presents the height information derived from the AFM images, revealing the thickness of monolayer MoSe₂ of about 0.8 nm and the DAE layer of about 2 nm. DAE has an absorption range in the visible spectrum from about 450 nm to about 650 nm (reference is also made to FIG. 5c and FIG. 5d, discussed above). To avoid the absorbance range and excite MoSe₂ exclusively, we selected a 785 nm laser for excitation as energy pump. To study the interaction of MoSe₂ with closed- and open-form DAE, we irradiated the hybrid MoSe₂/DAE sample with UV (˜312 nm for 30 seconds) and visible light (530-nm long-pass filter for 10 minutes), as modulation lights, respectively.

Monolayer MoSe₂/DAE exhibited strong PL signature peaking at about 795 nm (as shown in FIG. 7e which provides graphs of PL intensity vs. input energy in eV. Specifically, FIG. 7e PL spectra of MoSe₂/DAE (in linear scale) measured under a confocal Raman microscope with a 785-nm diode laser excitation. After visible and UV irradiation, the sample displays PL emission peaks at approximately 795 nm (˜1.56 eV). The sharp feature at ˜818 nm (corresponding to ˜520 cm⁻¹) is the Raman signature of the silicon substrate). After UV irradiation, the closed-form isomers promoted the photoexcited electron transfer from MoSe₂ to DAE, which resulted in a drastic PL quenching by ˜80% in intensity compared to the open-form under visible light. Note that the intensity of the Raman signature did not change significantly during the PL quenching. The energetically favorable charge transfer mechanism is attributed to the closed DAE's LUMO energy being lower than the CBM of MoSe₂, as designed in our scheme. In contrast, the LUMO level of the open-form is higher than the CBM. Therefore, electron transfer is prohibited, and PL quenching is not observed. To test the reversibility and consistency of this photoswitching behavior, we repeatedly exposed the sample to visible and UV light for 10 cycles. The result in FIG. 7f, which is a graph of normalized PL intensity vs. photo-irradiation, shows remarkable stability of MoSe₂/DAE photoswitch with a steady quenching ratio, ranging between 70% to 85%. Specifically, FIG. 7f shows cyclic measurements of the PL modulation with alternating visible and UV irradiation. Ten cycles of PL modulation demonstrate photoswitchable optoelectronic properties of monolayer MoSe₂ with photochromic DAE. During the cycle repetition, there is a gradual decrease in PL intensity difference between visible and UV irradiation. For example, it gradually drops to about 90% of the initial PL difference after the 10^{th} cycle. This degradation, termed fatigue, results from the irreversible formation of byproducts during repeated switching, which may be slowed down by optimizing the ligands or functional groups.

We also measured PL to probe interfacial charge transfer behaviors in the MoS₂-DAE hybrids using a confocal Raman microscope. To explore wavelength-dependent photoswitchability, we initially exposed the samples to visible light (using a 530-nm long-pass filter) as the modulation light for 10 minutes to trigger DAE isomerization to the open isomeric form. After the exposure, we recorded the PL spectra using a 633-nm HeNe laser for excitation. Note that DAE molecules exhibit minimal absorbance at 633 nm. Subsequently, we irradiated the samples with UV light (about 312 nm) as modulation light for 2 minutes to switch it to the closed form and compared the resulting PL intensities. The alternating UV-visible light exposure was performed three times, and the results are presented in FIGS. 7g, 7h, and 7i, which are graphs of PL intensity vs. wavelength. Specifically, FIGS. 7g-7i provide PL intensity of 1 L, 2 L, and 3 L MoS₂-DAE samples measured under alternating UV-visible irradiation. FIG. 7g represents the 1 L MoS₂ which shows a drastic PL quenching after UV irradiation. Advantageously, the signal recovers fully under visible light. This photo-modulation is repeated three times. In contrast, no significant PL quenching is observed from the hybrids with (FIG. 7h) 2 L and (FIG. 7i) 3 L MoS₂. The sharp Raman peak at ˜650 nm indicates the fingerprint of A_{1g} band in MoS₂, which is consistent with previous reports. Comparing the PL characteristics of IL, 2 L, and 3 L MoS₂, distinct patterns emerge. The 1 L MoS₂-DAE sample shows a distinct PL peak at approximately 660 nm, indicative of a direct bandgap. The PL peaks of 2 L and 3 L hybrids shift to about 670 and 680 nm, respectively. Reference is also made to FIG. 7j and FIG. 7k, which are AFM image of MoS₂ flakes featuring 1 L (FIG. 7j), 2 L, and 3 L (together FIG. 7k), with the boundaries highlighted by dotted lines. FIG. 7g shows a substantial PL quenching in 1 L MoS₂-DAE after UV irradiations. The emission signals are recovered after exposure to visible light. This behavior is associated with DAE's isomeric forms since 1 L MoS₂ without a DAE layer does not show any significant differences between UV and visible irradiation.

This behavior is attributed to photoinduced charge transfer at the hybrid interfaces that suppresses excitonic recombination of electron-hole pairs in MoS₂. Three consecutive cycles of visible and UV exposure result in consistent PL quenching and recovery, in line with what is expected from robust photoswitching (no significant degradation in performance due to undesired formation of irreversible photo-products.

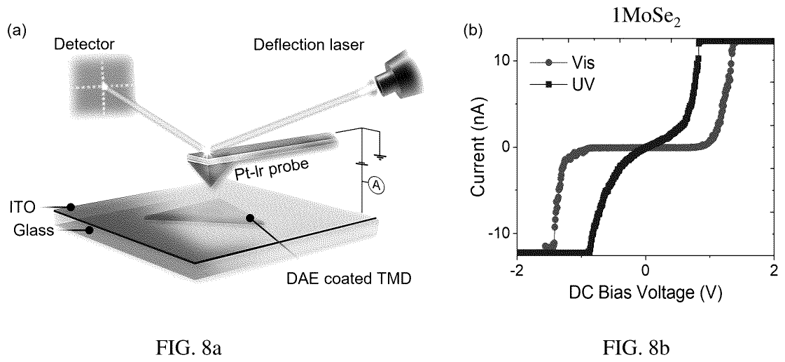

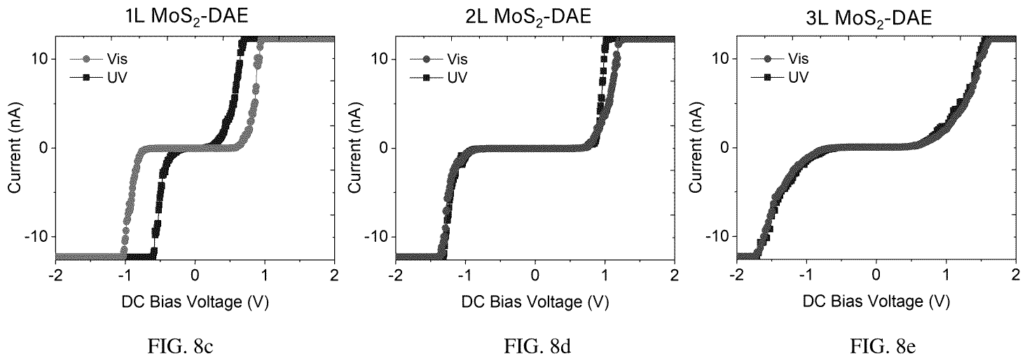

UV irradiation to yield the ring-closed isomers will not only facilitate photoinduced electron transfer, suppressing excitonic recombination and leading to PL quenching, but also increase the conductivity in MoSe₂. To probe this effect, we prepared DAE-coated MoSe₂ flakes onto ITO glasses and examined them under C-AFM for current-voltage measurements. The samples were placed between the ITO and Pt—Ir probe as depicted in FIG. 8a, which is a schematic of a Conductive-AFM setup where a TMD flake is exfoliated onto an ITO substrate and then coated with the DAE layer while applying a DC bias voltage of ±2 V and limiting the current to ±12 nA to protect the samples and the tip from localized charges. The results for open- and closed-ring isomers are shown in FIG. 8b, which provides graphs of current in nA (see I_{D}S with reference to FIG. 2a and FIG. 2b) vs. DC bias voltage (see V_{DS} with reference to FIG. 2a and FIG. 2b). The UV-irradiated closed DAE sample exhibited a significantly higher current than the MoSe₂ with open-ring DAE (under visible light) at the same applied potential. For example, the current after UV irradiation was greater than 12 nA in magnitude at ±1 V, while it is nearly 0 nA under visible light. This increase in current is attributed to the UV-induced promotion of charge separation and transport due to the LUMO energy lowered by ˜0.5 eV and below the CBM of MoSe₂. In contrast, the LUMO energy of the open DAE is higher than the CBM and does not facilitate current generation, unlike the closed DAE. Since the VBM of MoSe₂ is at approximately −5.35 eV, it is lower than the work function of ITO (about ˜4.75 eV)⁵². Therefore, a Schottky contact is established between MoSe₂ and ITO, developing the Schottky barrier and yielding nonlinear current behaviors. Similar graphs are shown in FIGS. 8c-8e. Specifically, conductive-AFM measurements on photoswitched hybrid samples under UV and visible irradiation were preformed resulting in (FIG. 8c) 1 L MoS₂-DAE, (FIG. 8d) 2 L MoS₂-DAE, and (FIG. 8e) 3 L MoS₂-DAE. Bias DC voltage was applied from −2 V to 2 V and currents were recorded within ±12 nA. UV light enhances the current significantly in 1 L MoS₂-DAE, whereas no significant changes are observed from the hybrids with 2 L and 3 L MoS₂.

When photoisomerization of DAE occurs, it alters the work function of MoSe₂/DAE due to interlayer charge transfer between MoSe₂ and DAE. We investigated the surface potential differences using KPFM to measure the change in work function. In the MoSe₂/DAE structure, the energy level shift caused by UV exposure results in electron transfer to DAE, balancing the energy gap. The work function was calculated as follows:

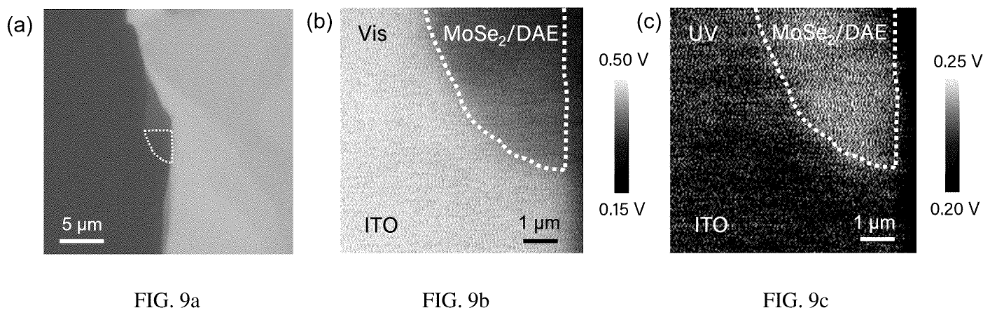

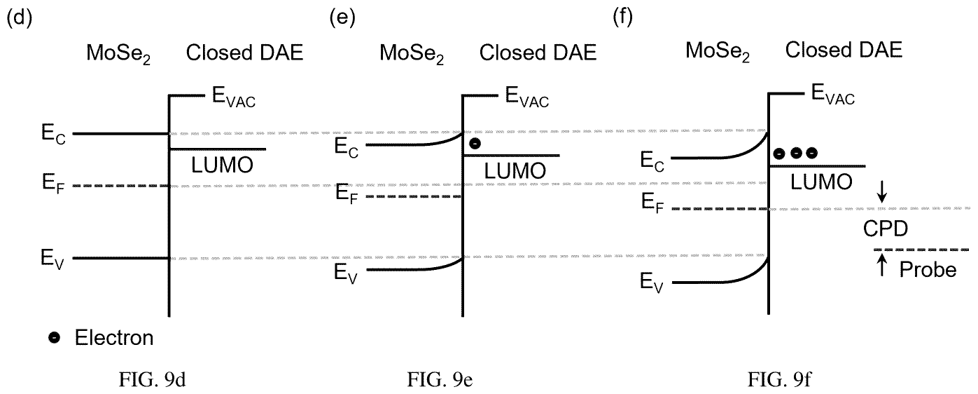

ΦS=Φtip+CPD

where CPD stands for contact potential difference, and Φ_{S} and Φₜᵢₚ are the work functions of the sample and Pt—Ir probe (˜5.05 eV), respectively. Referring to FIGS. 9a-9c, which are optical microscope image of MoSe₂ exfoliated on an ITO glass substrate and measured surface potential of MoSe₂/DAE (FIG. 9a) prior to any exposure following an exposure to (FIG. 9b) visible and (FIG. 9c) UV light. The average surface potentials are approximately 0.47 eV (Vis) and 0.22 eV (UV), from which we estimate work functions for MoSe₂/DAE of about −4.58 eV and −4.83 eV, respectively. After exposure to visible light, an average surface potential of approximately 0.47 eV is observed, while UV-irradiated MoSe₂/DAE displays a potential of ˜0.22 eV. From this measurement, we have determined work functions under two distinct light conditions by subtracting surface potential values from the Pt—Ir probe potential. An approximate value of −4.58 eV is obtained after visible light, while a work function under UV irradiation is about −4.83 eV. These results confirm the interlayer charge transfer occurring in the hybrid structure. Referring to FIGS. 9d-9f, energy diagram are provided of MoSe₂ in three different states: (FIG. 9d) before, (FIG. 9e) partially, and (FIG. 9f) after reaching equilibrium at the hybrid interface. Electrons exiting the semiconductor layer create the Helmholtz layer, resulting in the upward bending of the band structure. The depletion layer is formed at the contact of the MoSe₂ and DAE. As the transfer process progresses, the depletion layer thickens, leading to a decrease in the CBM and a lowering of the Fermi level of MoSe₂ and the LUMO of closed-ring DAE. This band modulation causes a reduction in CPD and increases the work function of the MoSe₂/DAE structure. If the sample is exposed to visible light, the DAE will shift from a closed to an open isomer, causing the LUMO to change from −4.31 eV to −3.80 eV. Charge transfer behavior and work function will change accordingly. The interplay between photoisomerization, charge transfer, and surface potential alterations in MoSe₂/DAE, as elucidated in this study, not only advances our understanding of hybrid materials but also opens new avenues for tailoring electronic properties in novel optoelectronic applications.

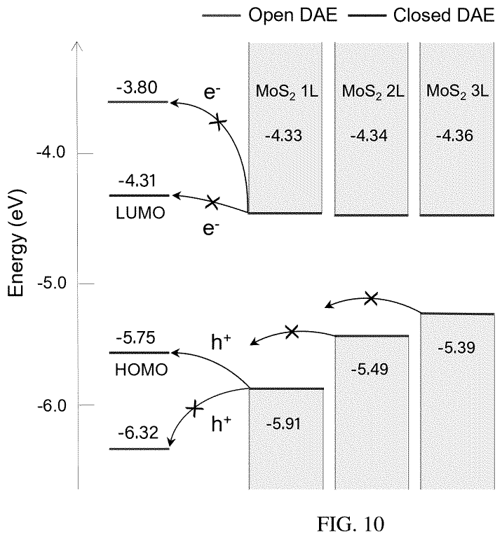

The energy band diagram in FIG. 10, which is an energy band diagram, illustrates the fundamental mechanisms involved in MoS₂-DAE hybrids based on DFT calculations. Since the LUMO levels of both the open and the closed isomeric forms of DAE are higher than the CBM levels of the MoS₂ layers, electron transfer from MoS₂ to DAE cannot take place. On the other hand, the HOMO level of closed-form DAE is higher than the VBM energy of 1 L MoS₂, which may facilitate the hole transfer from the 1 L MoS₂ to DAE. However, such transfer is unfavorable with 2 L and 3 L MoS₂. Overall, the photoswitchable hole transfer is a dominant mechanism that quenches PL and enhances conductivity of 1 L MoS₂. Furthermore, there is a strong layer-number-dependence that alters the interactions between MoS₂ and photochromic DAE molecules.

In order to fully enable making of the structures of the present disclosure, the following material preparation is offered as one exemplary embodiment. First preparation of MoSe₂ is described. P-doped SiO₂/Si substrates were used for the sample preparation. These substrates underwent sequential ultrasonication in the following order: acetone, methanol, and deionized water (DI), with each solvent treatment lasting 15 minutes. Subsequently, the substrates were subjected to forced air drying to remove residual fluids and then placed on a hot plate at 110° C. for 5 minutes. The mechanical exfoliation from bulk crystals (2D semiconductor) was applied to obtain MoSe₂ flakes. Briefly, Scotch magic tape was used to affix the exfoliated flakes for 10 minutes on a hot plate at 50° C., and they were then compressed for an additional 10 minutes. However, it should be noted that other deposition techniques known to a person having ordinary skill in the art are also possible, e.g., chemical deposition, e.g., chemical vapor deposition. Similarly, samples were also prepared on indium tin oxide glass (ITO, MTI KJ Group) substrates with the hot plate treatment extended to about 30 minutes. After tape removal, each sample was subjected to annealing under Argon gas at about 250° C. for an hour to improve interfacial contact and eliminate contaminants.

Next, preparation of DAE molecules is described. DAE was prepared according to a modified reference procedure. Knochel modification was applied to the Negishi coupling 2,4-dibromo-5-methylthiazole and 3,5-bis(trifluoromethyl)-1-bromobenzene for the obtention of 2-(3,5-bis(trifluoromethyl)phenyl)-4-bromo-5-methylthiophene. This intermediate was then transformed in situ to the corresponding boronic pinacol ester, necessary for the Suzuki coupling with 1,2-dichlorohexafluorocylopent-1-ene that gives access to the desired DAE.

Commercially available reagents and solvents were purchased and used as supplied. Reactions were monitored by analytical thin-layer chromatography (TLC) on a silica gel 60 F₂₅₄, Merck precoated silica gel plate, which were revealed by using a UV lamp. Flash-column chromatography was performed on Selekt flash chromatography systems (Biotage), using silica gel SNAP KP-Sil single-use column and solid deposition of the crude reaction.

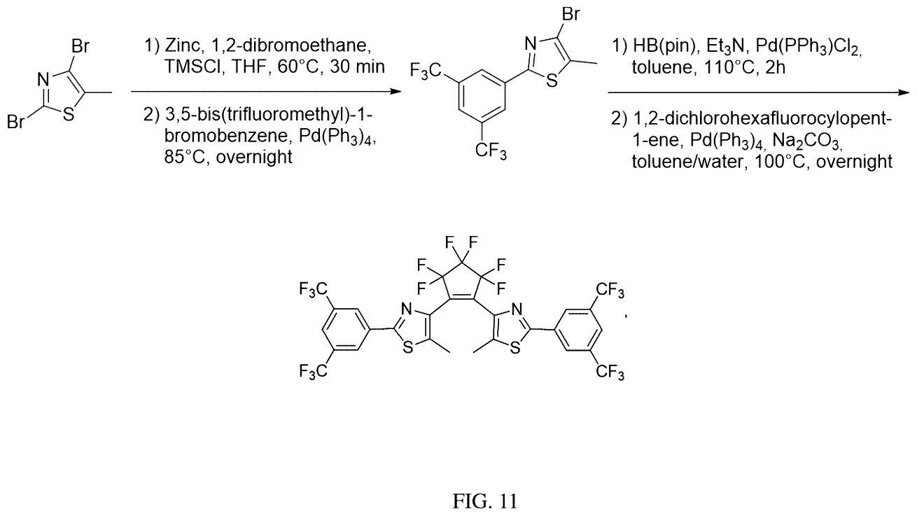

NMR spectra were recorded at room temperature on a Bruker Avance NEO spectrometer, operating at 600 and 151 MHz for ¹H and ¹³C, respectively. Chemical shifts were reported as values (ppm) with reference to the peak of DMSO-d₆. Abbreviation for the ¹H NMR data were as follows: chemical shift 6, multiplicity (s=singlet, d=doublet, t=triplet, q=quartet, m=multiplet, br=broad), coupling constants J. This procedure is shown in FIG. 11, which is a chemical representation of the synthesis according to the present disclosure.

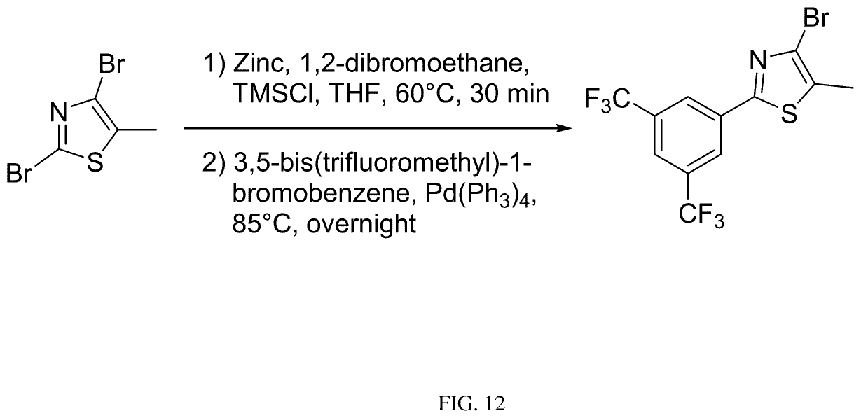

A known modification was adapted to a procedure for the synthesis of 2-(3,5-bis(trifluoromethyl)phenyl)-4-bromo-5-methylthiophene. LiCl (99 mg, 2.34 mmol, 2.96 equiv.) was placed in a nitrogen-flushed flask and dried. Zinc (157 mg, 2.40 mmol, 3.04 equiv.) was added under nitrogen, and the resulting mixture was dried again. Then THF (2 mL) was added, and Zn was activated by 1,2-dibromoethane (20 μL, 0.23 mmol, 0.23 equiv.; heating to ebullition for 15 seconds) and TMSCl (10 μL, 0.08 mmol, 0.1 equiv.; heating to ebullition for 15 seconds). 2,4-dibromo-5-methylthiazole (203 mg, 0.79 mmol, 1.0 equiv.) in 1 mL of THF was added to the reaction mixture via a syringe, and it was stirred for 30 min at 60° C. Then, 3,5-bis(trifluoromethyl)-1-bromobenzene (161 μL, 0.93 mmol, 1.18 equiv.) and Pd(PPh₃)₄ (95 mg, 0.08 mmol, 0.10 eq.) were added, and the mixture was refluxed at 85° C. overnight. After cooling to room temperature, it was diluted with Et₂O and filtered through Celite. Then, the organic phase was washed twice with aqueous HCl (1 M), aqueous saturated NaHCO₃ solution, and brine, and was dried over Na₂SO₄. After evaporation of the solvent the crude product was purified by flash chromatography (pentane/DCM, 9:1) yielding 2-(3,5-bis(trifluoromethyl)phenyl)-4-bromo-5-methylthiophene. (229 mg, 0.59 mmol, 74%) as a white solid. Proton NMR shown below agrees with previous reports in the art. FIG. 12, which is a chemical representation shows the process of synthesis of DAE (2-(3,5-bis(trifluoromethyl)phenyl)-4-bromo-5-methylthiophene).

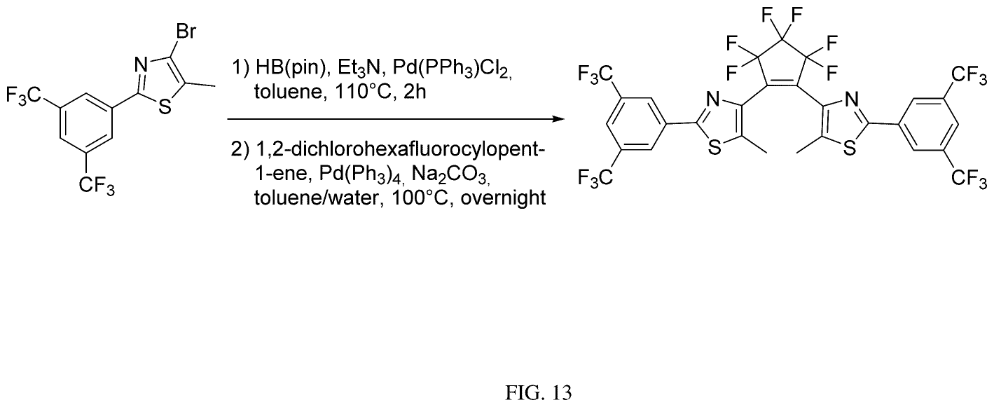

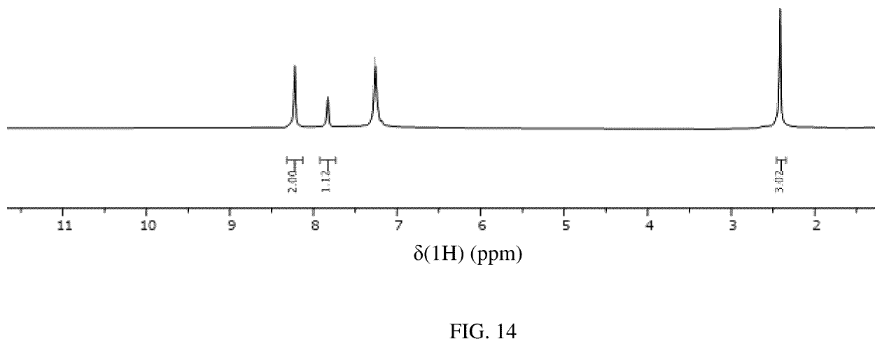

Desired DAE was prepared according to a known procedure. Previously prepared bromothiazole derivative (230 mg, 0.59 mmol, 1.0 equiv.), triethylamine (493 μL, 3.54 mmol, 6.0 equiv.), and Pd(PPh3)2Cl2 (23 mg, 0.03 mmol, 0.05 equiv.) were dissolved in 8 mL of dry toluene and the mixture was degassed by nitrogen bubbling. After the addition of pinacolborane (257 μL, 1.77 mmol, 3.0 eq.) the mixture was refluxed for 4 h at 120° C. After cooling to 80° C., an aqueous solution of Na2CO3 (2 M, 1 mL, 3.54 mmol) was added very slowly due to vigorous gas formation. Then, 1,2-dichlorohexafluorocylopent-1-ene (30 μL, 0.20 mmol, 0.33 eq.) and Pd(PPh3)4 (30 mg, 0.03 mmol, 0.03 eq.) were added and the mixture was stirred at 100° C. overnight. After cooling down to room temperature the mixture was extracted with ethyl acetate and the combined organic layers were washed with brine and dried over Na2SO4. Purification by flash chromatography (pentane/DCM 7:3) yielded the desired DAE (25 mg, 0.03 mmol, 16%) as a white solid. FIG. 13 shows a chemical representation of the desired DAE (4,4′-(perfluorocyclopent-1-ene-1,2-diyl)bis(2-(3,5-bis(trifluoromethyl)phenyl)-5-methylthiazole). Proton nuclear magnetic resonance (NMR) results of the synthesized DAE shown in FIG. 14 agrees with prior results in the literature. Specifically, FIG. 14 provides NMR results for ¹H-NMR (600 MHz, CDCl₃): δ (ppm)=8.22 (s, 2H, CHar), 7.82 (s, 1H, CHar), 2.41 (s, 3H, CH3).

Those having ordinary skill in the art will recognize that numerous modifications can be made to the specific implementations described above. The implementations should not be limited to the particular limitations described. Other implementations may be possible.

1. A DEVICE, comprising:
a substrate;
an atomic monolayer of a transition metal dichalcogenide (TMD) material formed on the substrate; and
a layer of photochromic diarylethene (DAE) disposed on the TMD material,
wherein the photochromic DAE layer has a thickness of between about 1 nm to 10 nm, and
wherein applying energy via a pump source causes the DEVICE to luminesce at a steady state level of intensity.

2. The DEVICE of claim 1, wherein the pump source is a photonic energy source.

3. The DEVICE of claim 2, wherein the photonic energy source is a laser.

4. The DEVICE of claim 3, wherein the laser is an HeNe laser operating at about 633 nm wavelength.

5. The DEVICE of claim 3, wherein the laser is an Ar⁺ laser operating at about 514 or about 488 nm.

6. The DEVICE of claim 3, wherein the laser is a diode laser operating at about 785 nm.

7. The DEVICE of claim 2, wherein when a modulation light having an intensity and wavelength is applied, the luminescence intensity modulates from the steady state of intensity to between 0% and a maximum intensity depending on the intensity of the modulation light, the wavelength of the modulation light, and duration of application of the modulation light.

8. The DEVICE of claim 7, wherein the modulation light is ultraviolet light having a wavelength between about 300 nm and about 400 nm at an intensity of between about 1 mW/cm² to about 10 mW/cm² for a predetermined period causing a reduction in luminescence intensity from a higher value of luminescence intensity to a minimum of 0%.

9. The DEVICE of claim 7, wherein the modulation light is visible light having a wavelength between about 500 nm and about 700 nm at an intensity of between about 1 mW/cm² to about 10 mW/cm² for a predetermined period causing an increase in luminescence intensity from a lower value of luminescence intensity to a maximum value of luminescence intensity.

10. The DEVICE of claim 1, further comprising a first electrical terminal disposed on the photochromic DAE layer at a first location of the DEVICE and a second terminal disposed on the photochromic DAE layer at a second location of the DEVICE, the first and second terminals configured to provide electrical energy to the DEVICE from a voltage source used as the pump source.

11. The DEVICE of claim 10, wherein when a modulation light having an intensity and wavelength is applied, the luminescence intensity modulates from the steady state of intensity to between 0% and a maximum intensity depending on the intensity of the modulation light, the wavelength of the modulation light, and duration of application of the modulation light.

12. The DEVICE of claim 11, wherein the modulation light is ultraviolet light having a wavelength between about 300 nm and about 400 nm at an intensity of between about 1 mW/cm² to about 10 mW/cm² for a predetermined period causing a reduction in luminescence intensity from a higher value of luminescence intensity to a minimum of 0%.

13. The DEVICE of claim 11, wherein the modulation light is visible light having a wavelength between about 500 nm and about 700 nm at an intensity of between about 1 mW/cm² to about 10 mW/cm² for a predetermined period causing an increase in luminescence intensity from a lower value of luminescence intensity to a maximum value of luminescence intensity.

14. The DEVICE of claim 1, wherein the TMD material is selected from the group consisting of molybdenum disulfide (MoS₂), molybdenum diselenide (MoSe₂), and combinations thereof.

15. The DEVICE of claim 1, wherein when a modulation light is applied, the luminescence modulates when the photochromic DAE layer modulates from an open state to a closed state.

16. The DEVICE of claim 1, wherein the TMD material is formed on the substrate based on a processing step selected from the group consisting of mechanical affixation, chemical deposition, chemical vapor deposition, and a combination thereof.

17. The DEVICE of claim 1, wherein the substrate material is selected from the group consisting of glass, Si, SiO₂, doped Si, SiC, Germanium, boron nitride, carbon, crystals, gallium arsenide, and combinations thereof.
